(19) United States
(12) Patent Application Publication
(10) Pub. No.: US 2026/0175939 A1
(43) Pub. Date: Jun. 25, 2026

(54) Main Frame, Front Fork, and Bicycle Frame Comprising Same

(71) Applicant: igus SE & Co. KG, Köln (DE)

(72) Inventor: Johannes Alderse Baas, Amersfoort (NL)

(21) Appl. No.: 18/868,589

(22) PCT Filed: May 24, 2023
(86) PCT No.: PCT/EP2023/063977

§ 371 Date: Nov. 22, 2024

(30) Foreign Application Priority Data
May 25, 2022 (DE) 20 2022 102 923.7

(51) Int. Cl. B62K 19/16; B29C 41/04; B29L 31/30; B62K 21/02

(52) U.S. Cl. CPC B62K 19/16; B29C 41/04; B62K 21/02; B29L 2031/3091

(57) ABSTRACT

The invention relates to a main frame (1) for a bicycle having a saddle and a front wheel and a rear wheel, which are arranged in alignment, which main frame is produced in a closed mold from a thermoplastic resin, the main frame being in the form of a single-piece hollow article (2) having a frame wall (3) which encloses the cavity thereof, and the frame wall (3) of the hollow article (2) consisting of one piece produced by means of rotational molding in a rotary mold that can be heated from the outside. The invention also relates to a front fork and to a bicycle frame comprising the main frame and the front fork.

The invention relates to a bicycle frame for a bicycle with a saddle, as well as with a front wheel and a rear wheel, which are arranged in one track, and relates to the main constituents thereof, namely a main frame and a front fork.

Firstly, the invention relates to a main frame which is produced from a thermoplastic in a closed mould. Secondly, it relates to a front fork which is produced from a thermoplastic in a closed mould.

In addition, the invention relates to a main frame for a bicycle with a saddle, as well as with a front wheel and a rear wheel, which are arranged in one track, produced from a thermoplastic, wherein a main support and a one-sided rear wheel support are comprised in one piece, wherein the rear wheel support is designed as a hollow body, with the proviso that the rear wheel support forms an encapsulating housing for a drive means, and that the rear wheel support is provided with a rear wheel receiver.

The invention furthermore relates to a front fork for a bicycle, which has a saddle, and which is provided with a front wheel and a rear wheel, which are arranged single-tracked, formed in one piece from a thermoplastic, comprising either a fork leg provided on one side and having an upper end and a lower end or two such fork legs arranged symmetrically, wherein a receiving opening is provided in each case at the lower end of the fork leg or the lower ends of the two fork legs, and wherein the receiving opening is adapted to hold a front axle.

Compared with steel and aluminium, thermoplastic has a lower strength as a material for a bicycle frame. The modulus of elasticity is lower than that of steel and aluminium. Likewise, the dimensional stability of plastic is lower. This must be taken into account in the construction of a main frame and a front fork from plastic, as is known from DE 38 04 342 C2.

This state of the art already proposes a bicycle frame made of a thermoplastic, which comprises a main frame and a front fork which are produced in an injection-moulding method, so-called thermoplastic injection moulding. The known injection-moulded main frame comprises a rear wheel support with a reinforcing ribbing and the front fork is reinforced with longitudinal ribs. In this state of the art, the lower strength of the plastic is to be compensated for by means of this reinforcing design.

The design of the main frame with ribbing as well as of the front fork with longitudinal ribs appears to be complex and the achievable strength properties appear to be unsatisfactory.

The object of the invention is to develop the bicycle frame so as to give the main frame and/or the front fork respectively such a spatially and physically simplified design, which can provide the strength and durability that are required for a bicycle frame and the named main constituents.

According to the invention this object is achieved according to claim 1 by a main frame which is designed as a one-piece hollow body with a frame wall surrounding the cavity, wherein the frame wall of the hollow body has a one-piece nature, which is produced by means of a rotational moulding in an externally heatable rotational mould.

For the rotational moulding, the thermoplastic material is poured, in the form of powder, into the rotational mould, which is closed all around for the moulding process. The rotational mould has an inner wall, which forms a negative of the shape to be moulded. The rotational mould is expediently formed as a permanent mould, which usually consists of metal, preferably aluminium. For the moulding process, the rotational mould is rotatable about at least one axis and is externally heated. The plastic powder melts in it and can be distributed over the inner wall in a viscous state as a melt. Finally, the melt solidifies on the inner wall of the rotational mould and can then be removed as a finished hollow body once the rotational mould has been opened.

The main frame for a single-track bicycle requires a dimensionally accurate shape. The inventor has discovered that it is advantageous for a main frame of a bicycle if plastic material, which already expands in the mould during the solidification, can expand freely inwards into the hollow rotational mould. In this way, a main frame moulded in a low-strain manner can be provided which has the dimensional accuracy required for a single-track bicycle and warps less than an injection-moulded main frame, which cannot expand at all in an injection mould and builds up stresses, which lead to warping. In addition, the rotationally moulded main frame is seamless because of its one-piece nature, which promotes strength.

The hollow body advantageously has regions with different wall thickness of the frame wall. In this way, the main frame can be adapted, without inner ribbing, such that particularly stressed points of the frame wall of the main frame in riding operation can be reinforced by more material in order to counteract cracks and breaks at these points.

The regions of different wall thickness of the frame wall are expediently generated by a heat input into the rotational mould from the outside which is different in regions. In regions heated more strongly the powder melts more quickly and over the course of the process a greater wall thickness can be built up in order to provide the necessary strength. It surprisingly became apparent that, even for a main frame with different wall thickness of the frame wall, a low stress is possible, which can provide the required dimensional accuracy.

With the rotational mould it is also possible to integrate separate components in the moulding process which are connected to the hollow body adhesively and/or in a positive-locking manner in the moulding process. These can be metallic component parts, for example rods, screws, rings or tubes, which can supplement and reinforce the main frame.

It is beneficial if the thermoplastic of the frame wall is selected from one of the following plastics: polypropylene (PP), preferably polyethylene (PE), particularly preferably high-density polyethylene (HDPE). Economic cycles which can recycle these plastics and provide them in a form prepared for re-use already exist for the named varieties. To this end they are for example collected from the sea and from agriculture. They are found in fishing nets, trawl nets, nets for aquaculture or as net wrapping for binding straw bales, moreover as scaffold netting for protecting road users. The recovery of such varieties directly from everyday products which are fed back into the cycle without polluting the environment beforehand is greatly promoted in the case of the proposed bicycle frame and the main constituents thereof.

It is very conducive to the re-use if the thermoplastic is fibre-free. Within the meaning of the present invention, this can also include a thermoplastic if it is sufficiently low-fibre to be processed such that it is suitable for a rotational moulding.

In addition, a main frame, if it comprises an encapsulating housing for a drive means, as defined in claim 6, also achieves the underlying object if the main support is designed hollow overall with opposite frame walls and is designed in one piece with the rear wheel support. Compared with the main frame known from DE 38 04 342 C2, the proposed main support dispenses with a ribbing and is instead designed as a hollow body overall with frame walls opposite each other. This design is to be achieved with different manufacturing methods. These include methods of primary shaping by means of a shaping tool or, for example, a 3D printing method, which can also process thermoplastic. The design of the main support as a hollow body overall and in one piece with a hollow rear wheel support is regarded as the invention.

The rear wheel receiver is advantageously formed as two coaxial bearing openings, wherein the coaxial bearing openings are arranged in the opposite frame walls of the rear wheel support. A bearing opening of the rear wheel support is located on the left side of the main frame in the riding direction, where the rear wheel is arranged in the ride-ready state of the bicycle. This side of the rear wheel support is to be called the wheel side and the opposite side of the rear wheel support is to be called the drive side. The bearing openings are expediently adapted to receive a shaft bearing for a rear wheel shaft. The bearing opening provided on the wheel side and/or on the drive side is expediently formed hollow cylindrical and has a locating surface for a bearing element in the axial direction. The diameter of the hollow cylindrical bearing opening preferably lies in the range of from 40 mm to 130 mm. The diameter of the hollow cylindrical bearing opening is expediently larger on the wheel side than on the drive side of the rear wheel support.

A main frame with an encapsulating housing for a drive means is also regarded as particularly beneficial if the frame wall of the hollow body has a one-piece nature, which is produced by means of a rotational moulding in an externally heatable rotational mould, as described above.

Furthermore, this hollow body can also have regions with different wall thickness of the frame wall. This can be achieved through a rotational moulding or for example by means of 3D printing.

As described above, thermoplastics can also be selected for this, such as polypropylene (PP), preferably polyethylene (PE), particularly preferably high-density polyethylene (HDPE); economic cycles which can recycle these plastics and provide them in a form prepared for re-use, which can be suitable for rotational moulding or 3D printing, already exist for these varieties. It is also conducive to this if the thermoplastic, as mentioned above, is fibre-free, wherein within the meaning of the present invention by this is also meant a low-fibre plastic if it can be processed and is suitable for a rotational moulding or 3D printing.

If a rotational moulding is provided, the regions of different wall thickness of the frame wall can again be generated by a heat input into the rotational mould from the outside which is different in regions, as described above.

Opposite wall regions of the main support are advantageously provided with coaxial bearing openings, which serve to receive a pedal drive.

One of the bearing openings for the pedal drive expediently serves in an integral manner as a maintenance opening for the rear wheel support, which is formed as an encapsulating housing for a drive means.

A further benefit can be to form the main support as a trapezoidal structure, which comprises a top tube element, a down tube element, a seat tube element and a head tube element. Since the main support is hollow overall, all of the mentioned tube elements of the trapezoidal structure form hollow regions of the main support.

A further improvement provides that the trapezoidal structure has a stiffening bridge element, which is arranged between the top tube element and the down tube element.

The seat tube element can have an upper seat tube extension, which protrudes beyond the top tube element.

The rear wheel support has a triangular structure. This structure includes the already mentioned seat tube element as well as an upper support element and a lower support element. The seat tube element is therefore an integral constituent of both the main support and the rear wheel support, it effectively forms an interface between main support and rear wheel support.

In this embodiment of the main frame too, the left side of the main frame in the riding direction is called the wheel side and the right side is called the drive side, which also refers to the rear wheel support. On the latter, the rear wheel is arranged mounted on one side on the wheel side in the ride-ready state of a finished bicycle.

If the lower support element of the rear wheel support is designed as a housing for a drive means, then it converges with the seat tube element at a front end of the lower support element. This region is adapted to receive a pedal drive, already mentioned. There is space for a bottom bracket or for a bottom bracket gearbox or for a bottom bracket drive, which can include an electric motor.

A stiffening bridge element can additionally be provided which extends from the top tube element to the seat tube extension. The bridge element reinforces the main frame. The seat tube extension is supported. In addition, the bridge element can serve as a design element, and can also fulfil a function as a grip element, in order to lift a bicycle when needed and to be able to carry it easily.

The main frame expediently has an envelope volume which lies in a range of from 18 to 22 litres, preferably in the range of from 19 litres to 21 litres and particularly preferably in the range of from 20 litres to 20.5 litres.

By envelope volume of the main frame within the meaning of the invention is meant the volume of the outer surface of the main frame, with the proviso that all openings present are interpreted as closed regions of surface and attributed to the outer surface. This means in particular that the outer surface which defines the envelope volume includes openings of the rear wheel receiver, openings in the region of the pedal drive receiver and in the region of the head tube element and of the seat tube element.

Moreover, seen individually or in combination with the named envelope volume, it is advantageous if the main frame has a weight in the range of from 3.5 kg to 5.5 kg, preferably in the range of from 4.0 kg to 5.0 kg and particularly preferably in the range of from 4.5 kg to 4.9 kg.

The main frame expediently has, in relation to its envelope volume, a specific weight in the range of from 0.16 kg/litre to 0.32 kg/litre.

The plastics proposed for the main frame, for example polyethylene (PE or HDPE) have a relatively low strength, hardness and rigidity. For other technological products, such polyethylenes are often reinforced by reinforcing fillers, such as fibres. For the sake of recyclability the present invention dispenses with fibre reinforcement and chooses homogeneous plastic. To provide the strength for a bicycle frame, the solution is a main frame designed as a bulky hollow body. Its volume is much larger compared with known bicycle frames made of steel or aluminium and also larger than the volume of a bicycle frame/main frame which is made of a fibre-reinforced plastic. If the strength is to be increased further, the internal volume of the hollow body can be provided at least partially with a foam.

The foam is expediently produced by foaming in the internal volume of the hollow body.

The main frame is expediently adapted such that after an impact test with a dropped weight of 22.5 kg from a drop height of 180 mm according to DIN-ISO 4210-6:2015, chapter 4.1 for city and trekking bicycles and according to the requirements of DIN-ISO 4210-2:2015, chapter 4.8.2 it has no cracks or breaks.

The main frame is expediently adapted such that after a dynamic test with pedalling forces F₁ of 1000 N according to DIN-ISO 4210-6:2015, chapter 4.3 for city and trekking bicycles and according to the requirements of DIN-ISO 4210-2:2015, chapter 4.8.4 it has no cracks or breaks after a required number of 100,000 test cycles.

The main frame can in addition be adapted such that after a dynamic test with a horizontal force F₂ of 450 N in the riding direction and a horizontal force F₃ of 450 N contrary to the riding direction according to DIN-ISO 4210-6:2015, chapter 4.4 for city and trekking bicycles and according to the requirements of DIN-ISO 4210-2:2015, chapter 4.8.5, with a replacement fork installed, it has no cracks or breaks after a required number of 100,000 test cycles.

Moreover, the main frame can be adapted such that after a dynamic test with a vertical force F₄ of 1000 N according to DIN-ISO 4210-6:2015, chapter 4.5 for city and trekking bicycles and according to the requirements of DIN-ISO 4210-2:2015, chapter 4.8.6 it has no cracks or breaks after a required number of 50,000 test cycles.

It is particularly helpful if the main frame is provided with a data storage element, preferably with an RFID storage element, in order preferably to store items of material information and/or data relating to the production of the main frame, in particular about the plastic material used. If a bicycle at the end of its life returns to the economic cycle, stored items of information can help to process and re-use the plastic as a homogeneous raw material.

Each main frame can be adapted to operate a rear wheel by means of a drive means which is designed as a traction mechanism with a tight strand and a slack strand, for example a bicycle chain or a toothed belt. For the case where such a drive means requires a certain tension in the tight strand and/or slack strand, the main frame is provided with a means which serves to provide a tension. The means can be a tensioning element or merely a provision on the main frame which serves to fasten a tensioning element.

To achieve the object, a front fork is furthermore used if it is formed as a hollow fork body with a fork wall, wherein the fork wall of the hollow fork body has a one-piece nature, which is produced by means of a rotational moulding in an externally heatable rotational mould.

The front fork is expediently formed such that the hollow fork body has regions with different wall thickness of the fork wall.

A further advantage is if the regions of different wall thickness of the fork wall are generated on the front fork by a heat input into the rotational mould from the outside which is different in regions.

The advantages of the different wall thickness of the fork wall as well as of the generation by targeted heat input correspond in principle to the above-described advantages of the rotationally moulded main frame if the latter has different wall thicknesses of the frame walls; reference is made to these advantages here, they apply equally to the front fork.

In addition, a front fork, if it either has a fork leg provided on one side or has two such symmetrically arranged fork legs, achieves the object in that a fork bridge region, to which, on one side, a fork arm which is oriented upwards is attached or two symmetrically arranged fork arms which are oriented upwards are attached, is formed at the upper end of the fork leg.

In the middle of the fork bridge a fork shaft is expediently provided, which can be able to be connected to the fork bridge region in a rotationally fixed manner as a metal tube and can be replaceable. Alternatively, the fork shaft can be placed in a rotational mould in order to be connected to the hollow fork body as an integral constituent of the front fork.

It is helpful if the fork arm has an upper end, wherein the upper end of the fork arm is connected to a handlebar element.

The handlebar element is expediently formed in one piece as part of the hollow fork body.

The handlebar element can in addition be divided in the middle and have a left handlebar half and a right handlebar half, each of which is connected to the corresponding left or right fork arm. The division of the handlebar element simplifies the installation of the front fork. For this, the fork arms are advantageously formed such that they can be elastically spread apart from each other. Thus, the handlebar halves can be moved far enough apart from each other to be able to insert the front fork, or its fork shaft, into a headset of a bicycle frame. The fork arms then spring back and are fixed.

A connection system is expediently provided for the fixing. The handlebar halves are advantageously designed as part of the connection system. For this purpose, the handlebar halves can each be provided with an upwardly and a downwardly pointing conical piece. The two conical pieces, which belong to one handlebar half, are expediently formed in one piece with that handlebar half. If the conical pieces of the two handlebar halves are fitted against each other, they expediently form a double-cone element. The double-cone element is thus divided in a vertical plane and comprises one double-cone side allocated to each handlebar half. The double-cone sides are favourably a one-piece constituent of the hollow fork body.

Moreover, it is useful if a lower cup-shaped clamping element is provided. It is expediently arranged on the fork shaft and has an inner surface which is conical. The inner surface is expediently adapted to nestle up against the downwardly pointing conical pieces of the two handlebar halves when the handlebar halves are fitted together in the middle and form the described double-cone element.

In the same way, a cover-like upper clamping element can be provided. This can advantageously seal the free end of the fork shaft. In a simple manner, it is also provided with a conical inner surface. This inner surface is expediently adapted to nestle up against the upwardly pointing conical pieces of the two handlebar halves when the handlebar halves are fitted together in the middle.

The upper clamping element can furthermore be provided with a through opening for an adjustment screw, which can protrude into the fork shaft and can be screwed into a nut element, as is usual in the case of an Ahead headset.

By means of the adjustment screw, on the one hand, the handlebar halves are fixed exactly and at the same time they are connected to the fork shaft. In addition, an axial play of a headset is adjustable by means of the adjustment screw.

The proposed connection system is therefore adapted such that it can bring about both the connection of the two handlebar halves and the fastening thereof to the fork shaft with a single adjustment screw. In addition, it is useful if the receiving opening of the fork leg provided for holding a front axle forms a downwardly open dropout, into which the front axle can be inserted from the side.

A closure element is expediently provided, with which the downwardly open dropout can be closed.

The closure element can be a component separate from the hollow fork body. There is therefore the possibility of using a different plastic material for the closure element as well as a different production method from that used for the hollow fork body.

At least one connection means is preferably provided, which serves to fasten the closure element to the fork leg, with the result that a fixing of the front axle can be brought about. The fixing can be effected in a positive-locking and/or force-fitting manner. In a simple manner, the dropout and the closure element have the shape of semi-cylindrical shells, between which a clamping slot remains. The closure element can then be able to be fastened to the dropout with screws as connection means. For this, the region of the dropout on the hollow fork body is expediently provided with at least one threaded insert, preferably two threaded inserts. Matching this, the closure element is provided with at least one push-through opening for a screw, or two push-through openings. In this way, a receiving opening is created with which a clamping action can be generated in order to fix an axle element.

It is particularly expedient if the front fork has an envelope volume which lies in the range of from 3.5 litres to 6.5 litres, preferably in the range of from 4.5 litres to 5.5 litres and particularly preferably in the range of from 4.7 litres to 5.3 litres.

By envelope volume of the front fork within the meaning of the invention is meant the volume of the outer surface of the front fork, with the proviso that all openings present, as in the definition of the envelope volume of the main frame, are interpreted as closed regions of surface and attributed to the outer surface of the front fork.

Moreover, seen individually or in combination with the named envelope volume, it is advantageous if the front fork has a weight in the range of from 1.9 kg to 3.7 kg, preferably from 2.4 kg to 3.2 kg and particularly preferably from 2.7 kg to 2.9 kg.

The front fork favourably has, in relation to its envelope volume, a specific weight of from 0.29 kg/litre to 1 kg/litre.

A further benefit for this front fork is also seen as being if the one-piece nature of the hollow fork body is produced by means of a rotational moulding in an externally heatable rotational mould.

The hollow fork body can have regions with different wall thickness of the fork wall.

The regions of different wall thickness of the fork wall can be generated by a heat input into the rotational mould from the outside which is different in regions.

The advantages of the different wall thickness of the fork wall as well as of the generation by targeted heat input also correspond, for this front fork, in principle to the above-described advantages of the main frame if the latter has different wall thicknesses of the frame walls due to rotational moulding.

A front axle is very advantageously allocated to the front fork as a structural component part.

The front axle can comprise two cup-shaped or two hollow cylindrical axle elements, wherein each axle element has a bearing seat for a wheel bearing as well as a mating region for the purposes of connection to the dropout of a fork leg. The bearing seat and the mating region are arranged on the circumference. The mating region has a cylindrical or polygonal cross section, with the proviso that the unit consisting of dropout and closure element has a matching hollow cylindrical or hollow polygonal cross section. The front axle is arranged rotationally fixed relative to the rest of the front fork. In the installed state, the front axle forms a structural reinforcement of the front fork.

In a simple manner, the two axle elements of the front axle can be connected to each other in a line in order to provide an axle connection. Each axle element has a connection end. The axle connection can be produced by means of the connection ends.

The connection ends of the two axle elements are expediently formed such that the axle connection can be produced by means of a screw connection.

The screw connection can have a separate screw and a separate nut or an internal screw thread is integrated in one of the axle elements and can cooperate with a screw.

The screw connection is preferably provided by a connection end which is formed as an external thread on a cylindrical outer surface of one of the axle elements, wherein the connection end of the other axle element is formed as a matching internal thread. This embodiment allows the axle elements to be designed hollow cylindrical. Weight savings can thereby be made. Moreover, the hollow embodiment represents an appealing design element.

The front fork can, like the main frame, be provided with a data storage element, preferably with an RFID storage element, in order preferably to store items of material information and/or data relating to the processing of the plastic material used for the front fork.

The plastics proposed for the front fork correspond to those for the main frame. In the case of polyethylene (PE or HDPE) for example, they have a relatively low strength, hardness and rigidity, because reinforcing fillers, such as fibres, are dispensed with for the sake of recyclability, and instead homogeneous plastics are used. To provide the strength for a bicycle frame, the solution is to also design the front fork as a bulky hollow fork body. The volume thereof is much larger compared with the volume of known front forks made of steel or aluminium and is also larger than the volume of a front fork which is produced from a fibre-reinforced plastic, for example a front fork made of carbon.

The invention furthermore comprises a bicycle frame for a bicycle with a saddle, as well as with a front wheel and a rear wheel in one track, comprising a main frame according to one of claims 1 to 25, as well as comprising a front fork according to one of claims 26 to 46.

The front fork advantageously has two fork legs. A bicycle frame is thereby provided which combines a one-sided rear wheel support for the rear wheel with a two-sided bearing for the front wheel.

Bicycle frame according to claim 41 or 42, characterized in that the main frame and the front fork form a unit in the installed state, wherein when the unit is subjected to an impact test, after the impact test with a dropped total weight of 90 kg, which is composed of partial weights, namely a weight M₁ of 50 kg on the seat tube element, a weight M₂ of 10 kg on a test steering head and a weight M₃ of 30 kg on a test bottom bracket, in the case of a drop height of 200 mm according to DIN-ISO 4210-6:2015, chapter 4.2 for city and trekking bicycles and according to the requirements of DIN-ISO 4210-2:2015, chapter 4.8.3 it has no cracks or breaks.

The bicycle frame proposed here and respectively the main frame and/or the front fork are thus formed to be used in an economic cycle. For this purpose, the material which is used to produce main frame and/or the front fork is to be an easily recyclable thermoplastic. A plastic is easily recyclable when it accumulates homogeneously. The fact of being homogeneous facilitates the processing before re-use and simplifies the cycle economy. In this way, an old bicycle frame can serve as raw material in order e.g. to produce a new bicycle frame.

The proposed main frame and/or the front fork promote the use of a recyclable thermoplastic. The proposed solution includes already using a recycled plastic for the first production.

A50 Finally, another bicycle component part from the group: main frame, front fork and wheel is proposed. This bicycle component part comprises a one-piece hollow body with a component part wall surrounding its cavity, wherein the component part wall of the hollow body is produced from a thermoplastic in a closed mould and has a one-piece nature, which is produced by means of a rotational moulding in an externally heatable mould provided for the rotational moulding, with the additional proviso that a foam is arranged in the cavity, and that the foam extends at least partially as a foam layer over the inside of the component part wall or preferably completely fills the cavity.

The process of foaming is advantageously carried out inside the cavity. The process of foaming is preferably carried out when the rotational moulding of the component part wall is still in progress with molten thermoplastic for the rotational moulding of the component part wall. A starting material of the foam is poured into the cavity forming, in order to foam therein, using at least one suitable pouring means which is provided on the mould. The starting material is easily poured into the same opening of the mould as the thermoplastic for the component part wall beforehand. A supply tube can be used which can be inserted into the mould. It can be inserted so deeply that it penetrates the layer of molten thermoplastic which has already formed on the inside of the mould. The pouring of the foam starting material can be easily carried out when the rotational movement of the mould is stopped. The rotational movement of the mould is not only a circular movement, but advantageously a complex three-dimensional movement in space. To pour the foam starting material, it is possible, for example, to stop a component of the complex movement in order then to be able to insert the supply tube into the pouring means of the mould and pour the foam starting material into the cavity remaining.

In principle, the process of foaming can be a physical process or the process of foaming is based on a chemical reaction. The starting material of the foam is expediently poured in the form of a granular material using the pouring means of the mould until it reaches the cavity forming. For the chemical foaming, the granular material of the starting material can be easily provided with a foaming agent. The foaming agent is preferably designed such that it can evaporate through heat input. If the starting material also melts through the heat input, the evaporated foaming agent can foam the molten starting material.

The invention is illustrated hereafter by way of example in a drawing and described in detail with reference to several figures. There are shown in:

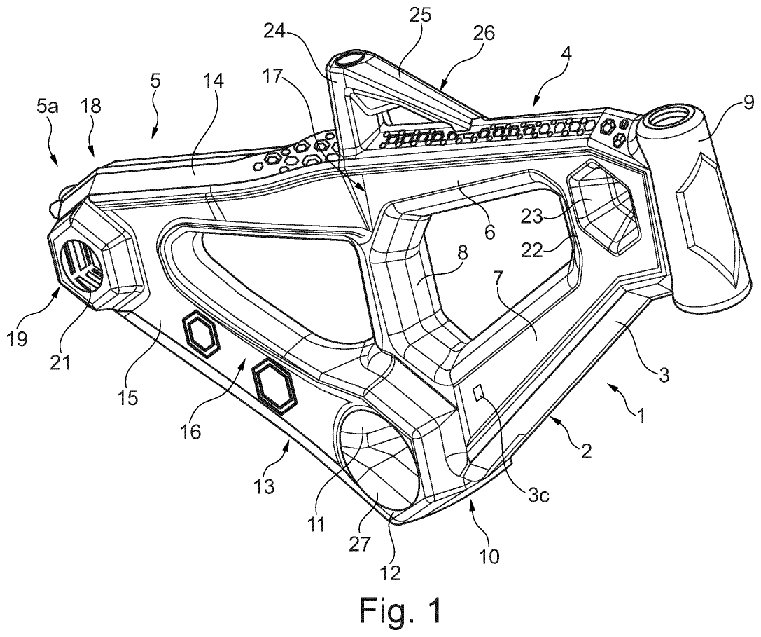

FIG. 1 a perspective view of a main frame according to the invention,

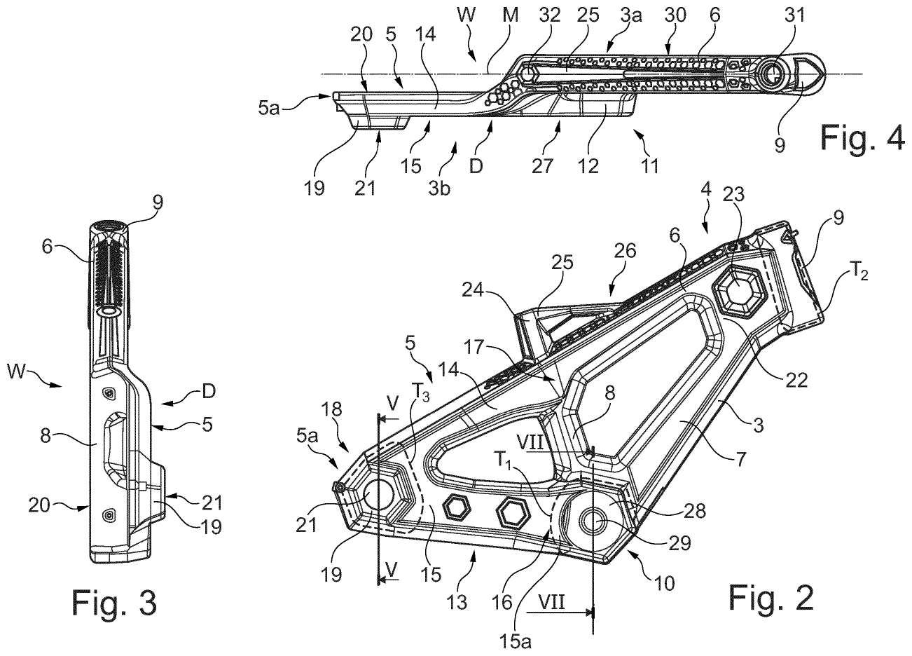

FIG. 2 a view of the right side of the main frame according to FIG. 1,

FIG. 3 a view from behind of the main frame according to FIG. 1,

FIG. 4 a top view of the main frame according to FIG. 1,

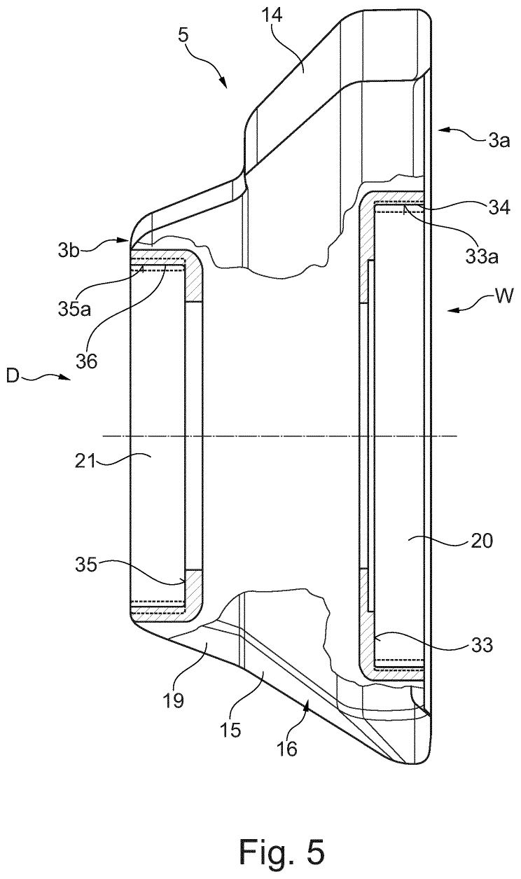

FIG. 5 a detail view of the rear wheel receiver along cutting line V-V in FIG. 2,

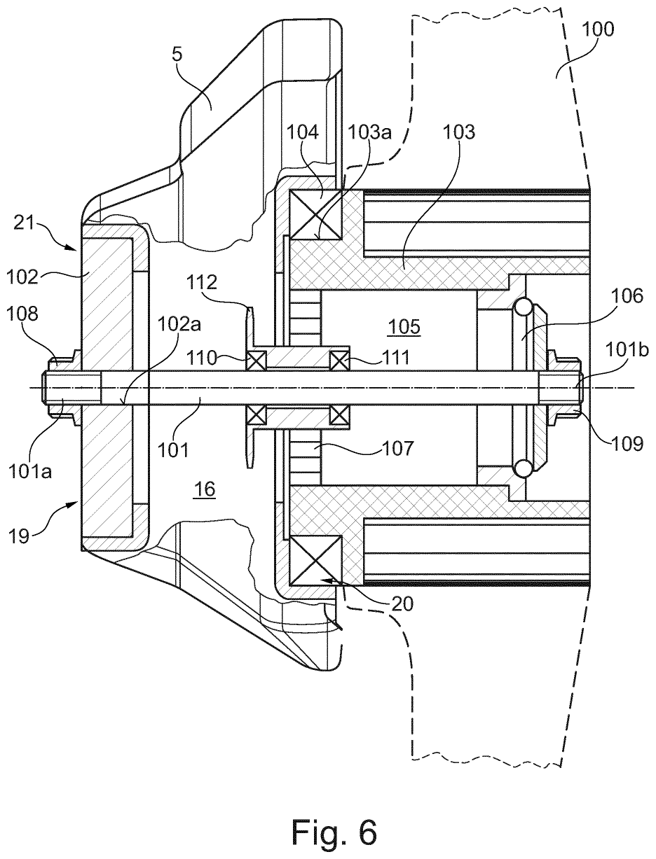

FIG. 6 a detail view along cutting line V-V in FIG. 2 relating to a rear wheel receiver for a standard axle,

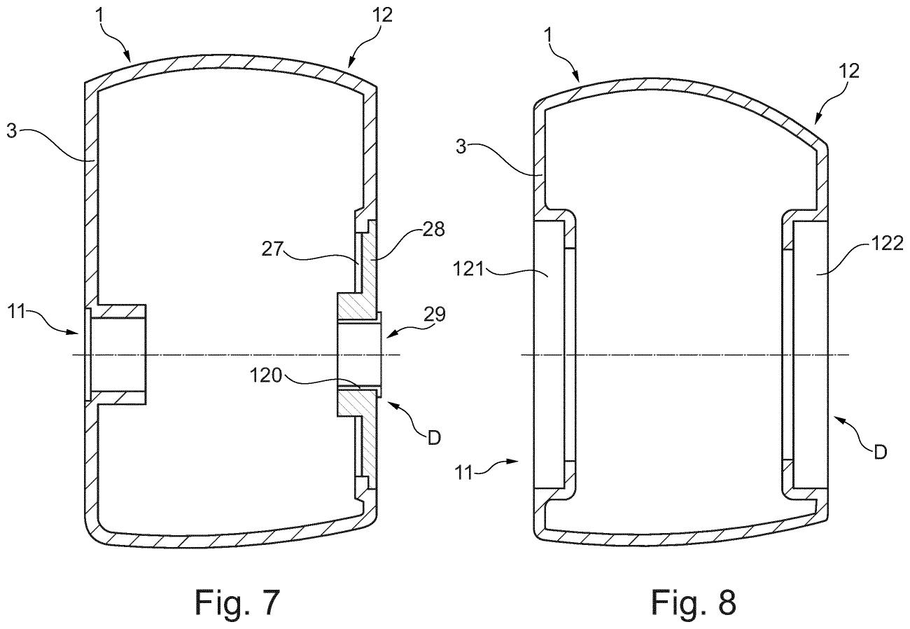

FIG. 7 a detail view of the pedal drive receiver along VII-VII in FIG. 2,

FIG. 8 detail view of an alternative pedal drive receiver along VII-VII in FIG. 2,

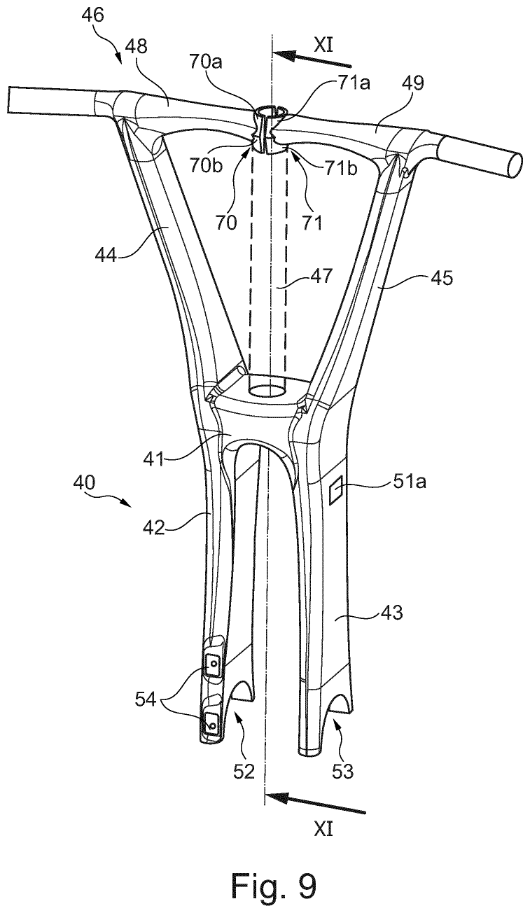

FIG. 9 a perspective view of a front fork according to the invention,

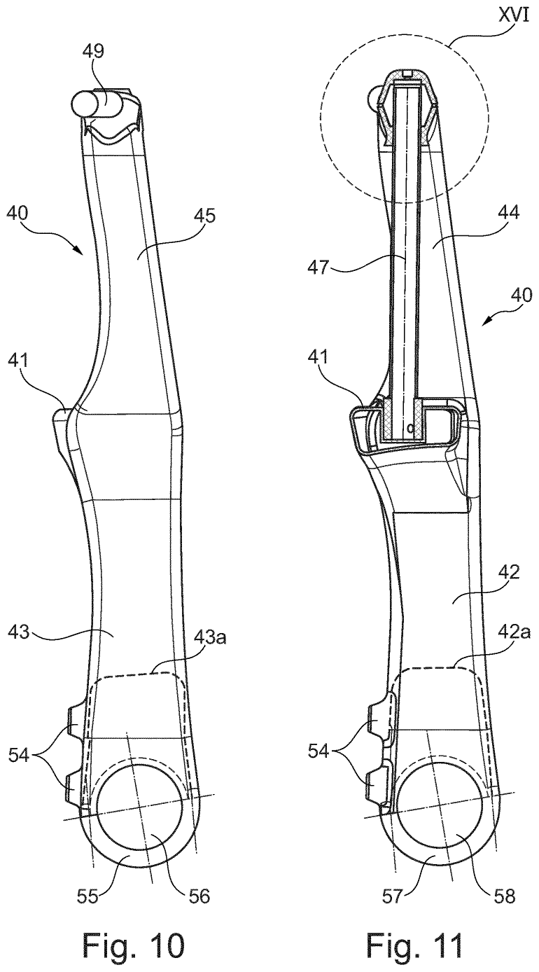

FIG. 10 a view of the right side of the front fork according to FIG. 8,

FIG. 11 sectional representation through the front fork according to FIG. 9,

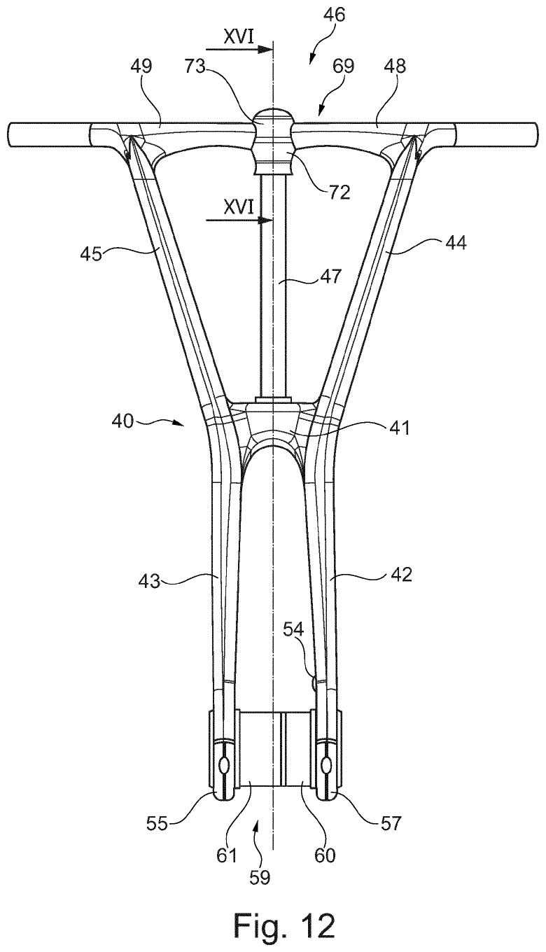

FIG. 12 a front view of the front fork with an installed front axle,

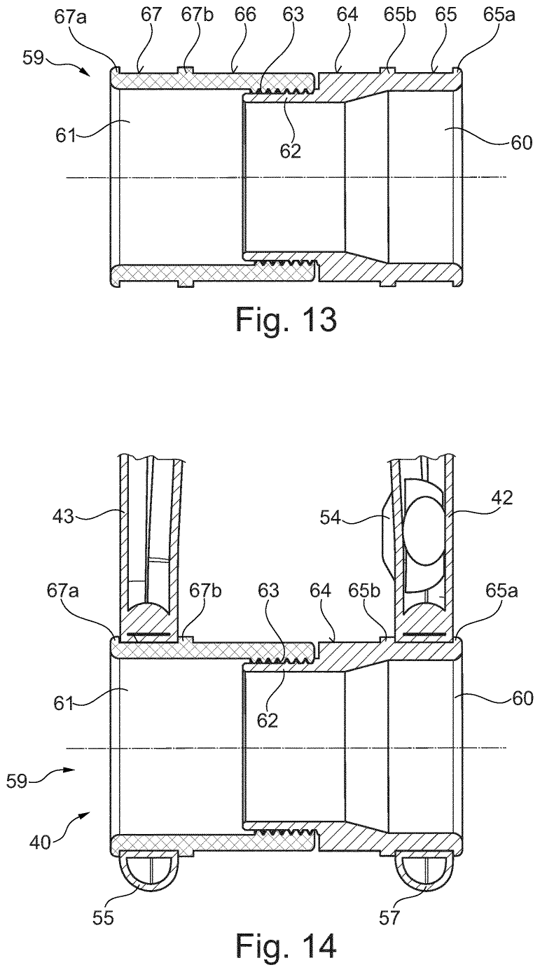

FIG. 13 the front axle from FIG. 12,

FIG. 14 a sectional representation in sections of the front axle in the installed state on the dropouts of the front fork,

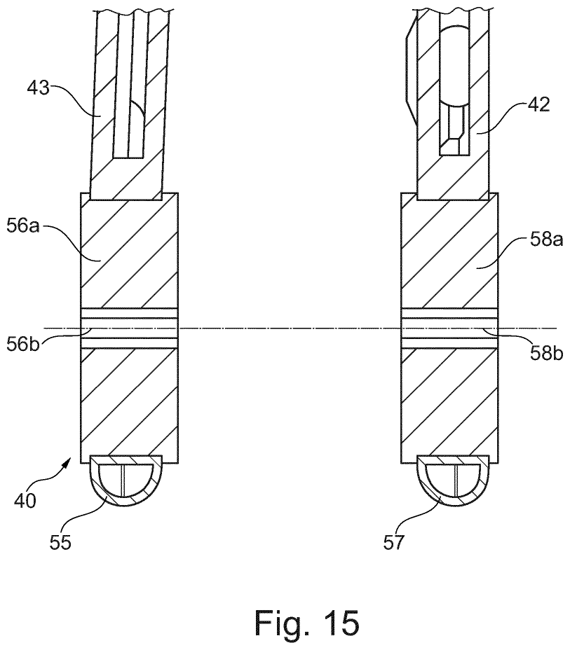

FIG. 15 an alternative design of the sectional representation in sections of the dropouts of the front fork for a standard axle,

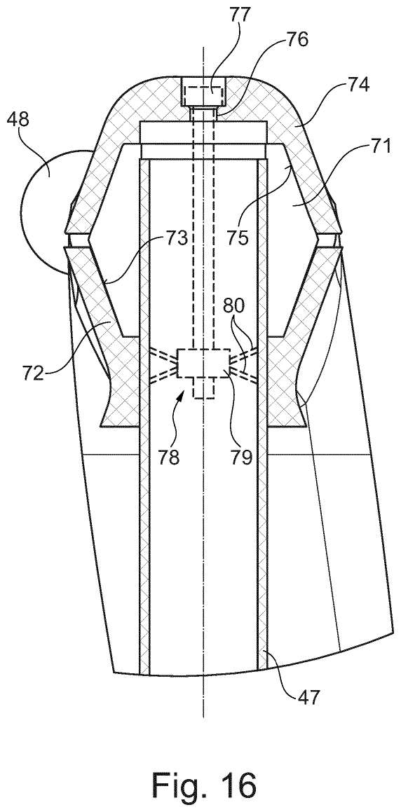

FIG. 16 a detail view along XVI-XVI in FIG. 12 of a connection system for handlebar halves,

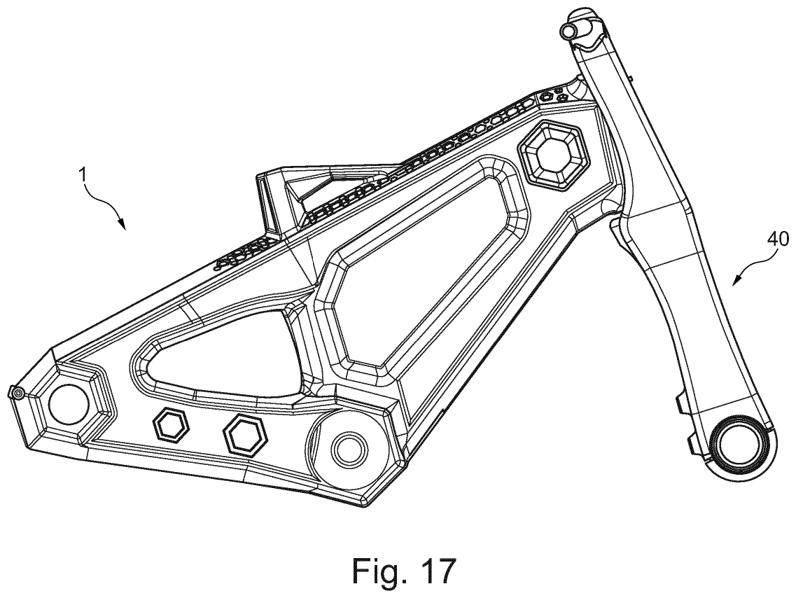

FIG. 17 a perspective view of a bicycle frame according to the invention, comprising a main frame and a front fork

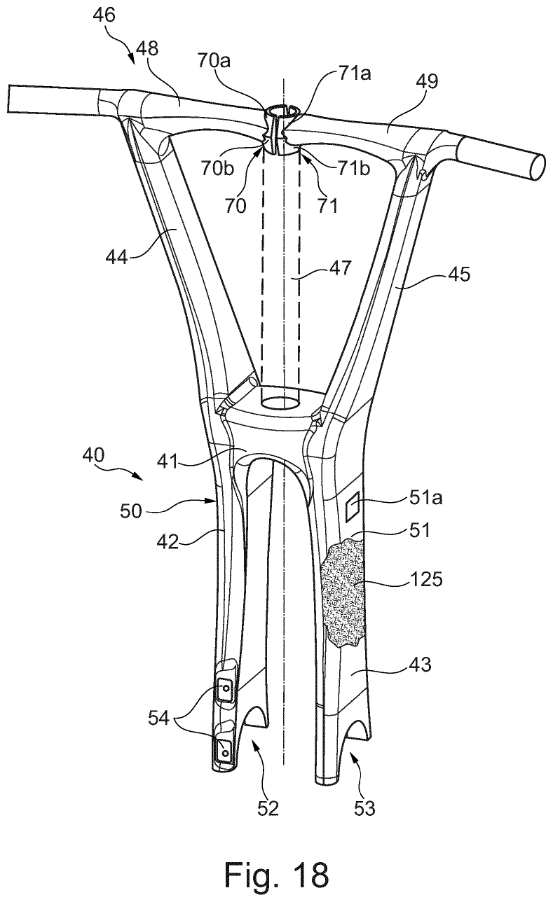

FIG. 18 a perspective view of an alternative front fork, based on the front fork of FIG. 9, designed as a bicycle component part with rotationally moulded hollow body and a foam filling,

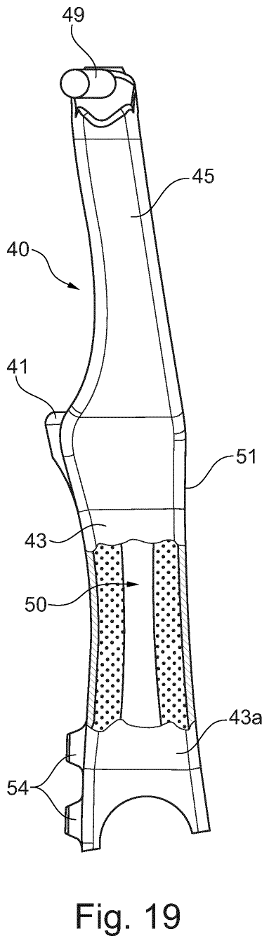

FIG. 19 a view of the right side of a further alternative of the front fork, based on the front fork of FIG. 10, designed as a bicycle component part with rotationally moulded hollow body with a layer of foam.

FIG. 1 shows an embodiment example of a main frame 1 according to the invention for a bicycle which is ridden in an upright position with a saddle as well as with a front wheel and a rear wheel. These wheels are arranged in the same track. The main frame 1 shown is produced as a hollow body 2 with a frame wall 3 surrounding the cavity. The hollow body 2 is formed in one piece, or its frame wall 3 is. The one-piece main frame 1 is produced from a fibre-free thermoplastic, here a homogeneously recycled high-density polyethylene (HDPE), by means of rotational moulding in an externally heatable rotational mould. The frame wall 3 is provided with a data storage element 3c, in which items of material information and/or data relating to the production of the main frame, in particular information about the plastic material used, are preferably stored.

To provide the strength required for a bicycle frame, the main frame 1 is designed as a bulky hollow body 2. Its external volume is much larger compared with the external volume of known main frames made of steel, aluminium or carbon.

The main frame 1 comprises a main support 4 as well as a one-sided rear wheel support 5, on which a rear wheel can be mounted on only one side.

The structure of the main support 4 has regions T₁, T₂ and T₃ with larger wall thickness of the frame wall 3. Furthermore, it is formed trapezoidal according to FIG. 1. A top tube element 6, a down tube element 7, a seat tube element 8 and a head tube element 9 are provided. All of the mentioned tube elements of the trapezoidal structure are bulky and hollow and form regions of the hollow main support 4. The down tube element 7 and the seat tube element 8 converge at a lower node 10 and there form a pedal drive receiver 11 in the form of a closed pedal drive housing 12.

The head tube element 9 is arranged at the front in the riding direction. It is adapted to receive a headset, which cooperates with a fork shaft. The head tube element 9 is designed hollow cylindrical. It is designed to receive a headset. By headset is meant for example a so-called Ahead headset, which comprises a lower bearing which is to be arranged at the bottom in the head tube element 9 as well as an upper bearing which is to be arranged at the top in the head tube element 9, as well as a tensioning device with an adjustment element for the fork shaft. The bearing play in the upper and lower bearings of the Ahead headset is adjustable by means of the tensioning device. In general, the terms “at the bottom” and “at the top” in the present description always refer to the main constituents of the bicycle frame, namely when a bicycle provided with them is in an upright position, such as in riding operation when travelling straight ahead.

The rear wheel support 5 has a triangular structure 13. This includes the already mentioned seat tube element 8 as well as an upper support element 14 and a lower support element 15.

The seat tube element 8 effectively forms an interface between main support 4 and rear wheel support 5. The left side of the rear wheel support 5 in the riding direction is called the wheel side W and the right side of the rear wheel support 5 is called the drive side D. The rear wheel is arranged on the wheel side Win the ride-ready state of a bicycle which has this main frame.

The lower support element 15 of the rear wheel support 5 is designed as a housing 16 for a drive means. At a front end 15a of the lower support element 15, it converges with the down tube element 7 and the seat tube element 8 at the lower node 10. The region of the lower node 10 is designed as the already mentioned pedal drive housing 12. There is space in the pedal drive housing 12 for a bottom bracket and in addition the space is alternatively sufficient for a bottom bracket gearbox. It would also be possible alternatively to accommodate a bottom bracket drive, which can include an electric motor.

The upper support element 14 of the rear wheel support 5 converges with the seat tube element 8 and the top tube element 6 of the main support 4 at an upper node 17. In a rear region 5a of the rear wheel support 5, the upper support element 14 and the lower support element 15 converge in a rear node 18 and there form a rear wheel receiver 19. The rear wheel receiver 19 is designed in the form of bearing openings. A bearing opening 20 is provided on the wheel side W and a bearing opening 21 is provided on the drive side D. The bearing openings 20/21 can be adapted in order to receive a shaft bearing for a drive shaft (not represented) which rotates relative to the rear wheel support 5 and to which a rear wheel can be fastened. Alternatively, the bearing openings 20 and 21 can be adapted in order to receive a rear axle (not represented) which is arranged fixed relative to the rear wheel support 5, with the result that a rear wheel mounted on the rear axle rotates. The rear axle can be a standard rear axle.

Furthermore, the trapezoidal structure of the main support 4 is provided with a stiffening hollow bridge element 22 which is arranged between the top tube element 6 and the down tube element 7. The bridge element 22 is arranged approximately parallel and close to the head tube element 9 according to FIG. 1. A polygonally open region 23 is provided between the bridge element 22 and the head tube element 9. The thus-formed bridge element 22 reinforces the main support 4 of the main frame 1.

In addition, the seat tube element 8 is provided with an upper seat tube extension 24, which protrudes upwards from the top tube element 6. A stiffening hollow bridge element 25, which extends to the top tube element 6, is provided on the seat tube extension 24. The seat tube extension 24 is supported in this way. In addition, the bridge element 25 serves as a grip element 26, in order to lift a bicycle when needed and to be able to carry it easily.

Furthermore, FIG. 1 shows that a large maintenance opening 27, which allows access to the housing 16 for the drive means which can be received encapsulated in the lower support element 15 of the rear wheel support 5 for the purposes of maintenance and installation, is provided on the drive side D in the region of the pedal drive housing 12.

A view of the right side of the main frame 1, i.e. the drive side D, is represented in FIG. 2. The pedal drive housing 12, the large maintenance opening 27 of which is sealed with a maintenance cover 28 here, is to be recognized. The maintenance cover 28 is for its part provided with a bearing opening 29, in order to receive a bearing element, for example for a crank arm.

On the left side of the main support 4 the pedal drive housing 12 can dispense with the maintenance cover, here only a bearing opening 30 for a crank arm is provided, as is to be recognized best in FIG. 7. In order to provide stable bearing openings 29 and 30, the region T₁ of the frame wall 3 is formed reinforced. A region T₂ of the frame wall 3 which forms the head tube element 9 is likewise formed reinforced.

FIG. 3 represents a view from behind of the main frame 1. It is to be recognized that the rear wheel receiver 19 on the rear wheel support 5 juts out the furthest laterally on the drive side D (to the right). This serves to provide a sufficient spacing between the bearing opening 21 of the drive side D and the bearing opening 20 on the wheel side W in order to be able to absorb forces/moments which are introduced into the rear wheel support 5 by a rear wheel arranged on one side. In order that stable bearing openings 20 and 21 can be provided, the region T₃ of the frame wall 3 is formed reinforced.

FIG. 4 is a top view of the main frame 1 according to FIG. 1 which shows the location of a middle line M of the main support 4. This middle line M coincides with the track in which the wheels of the bicycle are to be arranged. In the region of the rear wheel support 5, its asymmetrical one-sided location, namely on the right side of the track in the riding direction, is shown. The frame wall 3 of the main frame 1 has two frame walls 3a and 3b opposite each other. Also in the top view, on the drive side D it is to be recognized that the rear wheel receiver 19 on the rear wheel support juts out the furthest laterally on the drive side D. Moreover, it is represented that the pedal drive housing 12 is in a line with the lower support element 15 of the rear wheel support 5. Furthermore, the top view gives a view of an upper opening 31 of the head tube element 9 as well as of an upper opening 32 of the seat tube element 8.

FIG. 5 shows a cross section through the rear wheel receiver 19 of the rear wheel support 5 along the cutting line V-V in FIG. 2, namely in the marked direction of view. According to that, two bearing openings are provided, a bearing opening 20 on the wheel side W. A second bearing opening 21 is arranged coaxial with the bearing opening 20, namely on the opposite drive side D of the rear wheel support 5. The bearing openings 20/21 are adapted to receive a shaft bearing for a rear wheel shaft (not represented). The bearing openings are formed hollow cylindrical, in order to receive the shaft bearings. In the axial direction the bearing opening 20 has an inner locating surface 33, which serves as an axial locating surface for a bearing element. The cylindrical inner surface 33a serves as a seat for a bearing element. The diameter of the bearing opening 20 and the quality of the inner surface 33a must be designed to suit the desired bearing element, i.e., lie within a stipulated tolerance. The inner surface 33a can be a plastic surface. With the method of rotational moulding, it is possible to produce an accurately fitting bearing opening with a surface made of plastic. Alternatively, during the rotational moulding, a metal ring can be integrated which is prefabricated in an accurately fitting manner. Alternatively, an accurately fitting integrated aluminium ring 34 is indicated with a dot-dash line in the region of the inner surface 33a. The aluminium ring 34 is connected to the plastic of the rear wheel support by adhesion and/or positive locking.

The bearing opening 21 arranged on the wheel side W has an inner locating surface 35 as well as a cylindrical inner surface 35a. The dot-dash line in the region of the inner surface 35a indicates the alternative of an integrated accurately fitting aluminium ring 36. The aluminium ring 36 is also connected to the plastic of the rear wheel support 5 by adhesion and/or positive locking.

The bearing opening 20 has a larger diameter than the bearing opening 20 provided on the drive side D. This is advantageous if the drive means arranged in the encapsulated housing 16 is arranged closer to the wheel side W and higher forces tend to be expected there.

The diameter of the hollow cylindrical bearing openings 20 and 21 preferably lies in the range of from 40 mm to 130 mm. In the present example, the wheel-side bearing opening 20 has a diameter of 120 mm and the bearing opening 21 arranged on the drive side D has a diameter of 90 mm.

FIG. 6 also shows a cross section along cutting line V-V in FIG. 2, wherein the rear wheel receiver 19, together with a rear wheel 100 indicated as a dashed line, is represented with the aid of this sectional representation. In this example, a fixed solid rear axle 101 is provided. The one-sided rear wheel support 5 corresponds to the one according to FIG. 5, i.e., it has bearing openings 20 and 21. A cylindrical disc element 102, which is provided with a through opening 102a for the rear axle 101, is arranged in the bearing opening 21. The rear wheel 100 has a hub sleeve 103, which forms a seat 103a for a roller bearing 104, namely for an inner ring of the roller bearing 104, on the outside. The associated outer ring of the roller bearing 104 is installed in the rear wheel support 5, namely in the bearing opening 20 of the rear wheel support 5. The hub sleeve 103 furthermore has a hollow cylindrical internal space 105, which provides space for a roller bearing 106 as well as for a freewheel element 107. The roller bearing 106 is formed that it has to be pretensioned in the axial direction. The pretensioning is provided by means of the rear axle 101, which has thread ends 101a and 101b for this purpose in order to pretension them with axle nuts 108 and 109.

A sprocket 112, which is part of a bicycle drive, is mounted on the rear axle 101 by means of two roller bearings 110 and 111. In the installed state, the sprocket 112 cooperates with a bicycle chain (not represented) as a drive means, wherein the drive means is arranged within the rear wheel support 5. The rear wheel support 5 serves as an encapsulating housing 16 for the drive means and the sprocket 112.

The mentioned freewheel element 106 is thus connected between the sprocket 112 and the hub sleeve 103, that the transmission of a rotational movement is allowed only in one direction of rotation of the rear wheel and can transmit a torque.

With the example of FIG. 6, a rear wheel can, for example, be provided with a usual gear hub, which has a fixed axle. The axle can be a solid axle or alternatively a hollow axle.

FIG. 7 shows a cross section through the pedal drive receiver 11 of the main frame 1 along the cutting line VII-VII, which is noted in FIG. 2. The pedal drive receiver 11 comprises, on the drive side D, the maintenance opening 27, which is adapted to receive a maintenance cover 28. The maintenance cover 28 has a bearing opening 29, preferably for a plain bearing element 120, which serves to mount a crank arm (not shown). The plain bearing element 120 has a diameter of 30 mm in the example. On the opposite side the pedal drive receiver 11 has a bearing opening 30, in which a bearing element (not shown) for the crank arm, preferably also a plain bearing element, can also be received. The maintenance opening 27 for the maintenance cover 28 is provided with a diameter of 120 mm in the example.

FIG. 8 also shows a cross section through the pedal drive receiver 11 of the main frame 1 along cutting line VII-VII, as noted in FIG. 2. It is an alternative design of the pedal drive receiver 11, which differs by the altered bearing openings 121 and 122. Both bearing openings 121 and 122 have a large cross section. They are provided with a diameter of 120 mm in each case in the example. The large bearing openings serve for example to receive a roller bearing, the inner ring and/or outer ring of which are produced from a plastic. This embodiment makes it possible for example to receive a pedal drive which comprises a bottom bracket gearbox or for a bottom bracket drive with an electric motor.

The main frame shown with the aid of FIGS. 1 to 4 has an envelope volume of 20.25 litres with a tolerance of ±0.25 litres. Its weight is 4.75 kg with a tolerance of ±0.2 kg.

FIG. 9 is a perspective view of a front fork 40 according to the invention. The front fork is designed for a bicycle which is ridden in an upright position with a saddle. The bicycle is provided with a front wheel and a rear wheel, which are arranged in one track.

The front fork 40 has a stable fork bridge region 41. Two fork legs 42 and 43 are arranged symmetrically and oriented downwards in the fork bridge region. Moreover, a fork arm 44 or 45, which extends to an integrated handlebar element 46 and is connected thereto, is in each case attached to each fork leg at the top. A fork shaft 47, which is drawn in dashed, is provided in the middle of the fork bridge. In the present example, the fork shaft 47 is a metal tube, which is connected to the fork bridge region 41 in a rotationally fixed manner.

The handlebar element 46 is clearly recognizably divided in the middle. It has a left handlebar half 48 and a right handlebar half 49, each of which is connected to the corresponding fork arm. The division serves for the easy installation of the front fork 40. The fork arms 44 and 45 are formed such that they can be elastically spread apart from each other, in order that the handlebar halves 48 and 49 move sufficiently far apart from each other that the fork shaft 47 of the front fork can therefore be inserted into a headset of a bicycle frame. The fork arms then spring back and are finally fixed by means of a connection system, which is represented in FIG. 11 and best in FIG. 17.

The proposed front fork 40 is produced from a thermoplastic in a closed rotational mould. It forms a hollow fork body 50 with a fork wall 51. The hollow fork body 50 is in one piece and its fork wall 51 is seamless. In the present example, as mentioned, only the fork shaft 47 was subsequently inserted and connected to the fork bridge region 41 of the hollow fork body 50. The one-piece nature was produced by means of the rotational moulding in an externally heatable rotational mould, namely from a fibre-free thermoplastic, here a homogeneously recycled high-density polyethylene (HDPE). The subsequently inserted fork shaft 47 can alternatively also be placed in the rotational mould in order to be connected to the thermoplastic of the hollow fork body 50 during the process of rotational moulding. In this way, the metal tube of the fork shaft is then also provided as an integral constituent of the front fork.

The fork leg 44 is provided with a dropout 52 and the fork leg 45 is provided with dropout 53, in order to receive a front axle. It is a special front axle which has a large diameter, as the dropouts 52 and 53 reveal. The dropouts are formed downwardly open and a separate closure element is provided for each dropout 52/53, as described further below.

The fork leg 42 is moreover provided with a fastening element 54, which can be used, for example, to install a brake assembly, in particular for a brake calliper of a disc brake.

The hollow fork body 50 has regions with different wall thickness of the fork wall 51. The thicker regions of the fork wall 51 were generated by a heat input into the rotational mould from the outside which is higher in these regions. In the present example, lower regions 42a and 43a of the fork legs 42 and 43 are provided with a thicker fork wall.

The fork wall 51 is provided with a data storage element 51a, in which items of material information and/or data relating to the production of the front fork 40, in particular information about the plastic material used, are preferably stored.

The front fork 40 according to FIG. 10 has, including the closure elements 55 and 57, an envelope volume of 5 litres with a tolerance of ±0.15 litres. Its weight lies in the range of from 2.4 kg to 3.2 kg with a tolerance of ±0.1 kg.

FIG. 10 shows a side view of the front fork 40. A closure element 55 is installed on the dropout 53 of the fork leg 43. The closure element 55 supplements the dropout 53 and with it forms a receiving opening 56 for holding the special front axle. Connection means 55a and 57a in the form of screws (not represented) are provided in order to fasten the closure elements 55 and 57 to the fork leg 42 and 43 respectively. For the purposes of installation the front axle can be inserted from the side or from below and fixed to the closure element 55.

In the present example, the closure element 55 brings about a clamping connection, which fixes the front axle to the dropout in a rotationally fixed manner. Instead of a clamping connection, which has a friction-locking action, a positive-locking design could also be provided in order to realize a rotationally fixed fixing of the front axle in the receiving openings of the fork legs.

In order to provide the fixing in the present example, screws are provided as connection means. The dropouts are therefore provided with internal threads and, matching them, the closure element has through openings for the screws.

FIG. 11 shows a section along the cutting line XI-XI in FIG. 9, wherein the fork shaft 47 is represented in the representation of FIG. 11. The fork shaft 47 is held at the bottom in the fork bridge region 41 and held at the top by means of the already mentioned connection system, which is described in detail with the aid of FIG. 16. Furthermore, a closure element 57 which belongs to the dropout 52 of the fork leg 42 and which thus forms a receiving opening 58 for the front axle is shown in FIG. 11.

As illustrated in FIG. 12, a special front axle 59 is allocated to the front fork 40. The front axle 59 is a structurally important component part for the proposed front fork 40. For a front fork 40 which has a hollow fork body 50 made of a homogeneous plastic, it is beneficial to provide the front axle 59 as a stiffening component. The strength of the front fork 40 can thus be greatly improved.

The front axle 40 comprises two cup-shaped or, as represented in FIG. 13, two hollow cylindrical axle elements 60 and 61. The two axle elements of the front axle are arranged in a line and connected to each other. For this purpose, connection ends 60a and 61a respectively are provided, wherein the connection end 60a of the axle element 60 is provided with an external thread 62 and the connection end 61a of the axle element 61 has a matching internal thread 63, which are screwed to each other.

The axle element 60 has a bearing seat 64 for a wheel bearing. Moreover, the axle element 60 is provided with a cylindrical mating region 65 for the purposes of connection to the dropout 52 of fork leg 42. The mating region 65 comprises lateral bars 65a and 65b, as is to be recognized best in FIG. 14. The bars 65a and 65b have a spacing from each other which corresponds to the thickness of the fork leg 42.

The fork leg 42 is fixed between the bars 65a and 65b. In the same way, the axle element 61 is provided with a bearing seat 66 for a wheel bearing and has a mating region 67 for the purposes of connection to the dropout 53 of the fork leg 43. The mating region 67 is also provided with bars 67a and 67b. The bars fix the fork leg 43 in the axial direction of the front axle 59 in the same way.

The bearing seats 64/66 and the mating regions 65/67 are arranged on the circumference of the axle elements 60/61. In the present example, the mating regions 65/67 have cylindrical cross sections and are clamped in the receiving openings 56 and 58 respectively of the fork legs. In this way, the front axle 59 is arranged rotationally fixed relative to the front fork 40 and it serves as a structure-stiffening element of the front fork 40.

FIG. 15 shows an alternative design of the dropouts of the front fork for a standard axle. The fork legs 42 and 43 correspond to the ones in FIG. 14. An adapter element 56a or 58a is arranged in each of the receiving openings 56 and 58 respectively. The adapter elements 56a and 58a are identical component parts. They each have a central opening 56b and 58b respectively, which is adapted to receive a standard axle. The central opening 56b/58b is in each case an elongated hole. This makes it possible to adjust the alignment of a front wheel in the middle between the fork legs 42 and 43.

A detail view along cutting line XVI-XVI in FIG. 12 is represented in FIG. 16. The handlebar half 48 of the divided handlebar element 46 as well as the fork arm 44 which carries this handlebar half 48 are to be recognized. In order to be able to install the front fork 40 in a headset element of the main frame, the fork arms 44/45 with the handlebar halves 48/49 located thereon are spread apart from each other and spring back in the installed state. The handlebar halves are then fixed to each other and fixed to the fork shaft 47 by means of a connection system 68.

The proposed connection system 68 is adapted such that with a single screw it can bring about both the connection of the two handlebar halves 48 and 49 and the fastening thereof to the fork shaft 47. It comprises a double-cone element 69 which is divided in a vertical plane and forms two double-cone sides 70 and 71. The double-cone side 70 is allocated to the handlebar half 48 and the double-cone side 71 is allocated to the handlebar half 49. In the present example, the double-cone sides 70 and 71 are a one-piece constituent of the hollow fork body 50.

The double-cone side 70 comprises an upwardly pointing conical piece 70a and a downwardly pointing conical piece 70b and the double-cone side 71 comprises an upwardly pointing conical piece 71a and a downwardly pointing conical piece 71b.

Moreover, a lower cup-shaped clamping element 72 is provided which is arranged on the fork shaft 47. An inner surface 73 of the clamping element 72 is conical and nestles up against the downwardly pointing conical pieces 70b and 71b of the two handlebar halves 48/49, in order to fix them.

In the same way, a cover-like upper clamping element 74 is provided which seals the free end of the fork shaft 47. It has a conical inner surface 75. The inner surface 75 nestles up against the upwardly pointing conical pieces 70a and 71a, in order to fix them, or in order to fix the divided handlebar halves 48/48.

The upper clamping element 73 is provided with a through opening 76 for an adjustment screw 77. The adjustment screw 77 protrudes into the fork shaft 47 and is screwed into a nut element 78, which can be fixed in the hollow cylindrical fork shaft 47 in a friction-locking manner. In the example it is a claw nut 79, which can be fixed by means of resilient claws 80.

By means of the adjustment screw 77 the handlebar halves 48 and 49 are fixed exactly and at the same time they are connected to the fork shaft 47. In addition, an axial play of a headset is adjustable by means of the adjustment screw 77.

FIG. 17 shows a bicycle frame 81 comprising a main frame 1 and a front fork 40.

FIG. 18 represents a perspective view of an alternative bicycle component part. By way of example, it is explained with reference to a front fork how the alternative bicycle component part is constructed and how it is produced. The example of the alternative bicycle component part is based on the front fork of FIG. 9. According to FIG. 18, the bicycle component part is designed as a one-piece hollow body, here the hollow fork body 50 with a component part wall, here the fork wall 51, which surrounds its cavity. The fork wall 51 is produced from a thermoplastic in a closed mould. The one-piece nature of the fork wall 51 is produced by means of a rotational moulding in an externally heatable mould provided for the rotational moulding. The alternative of FIG. 18 differs from the example of FIG. 9 in that a foam 125, which fills the cavity in the present example, is additionally arranged in the hollow fork body 50.

The process of foaming was carried out inside the cavity, while the rotational moulding of the fork wall 51 was still in progress with molten thermoplastic for the fork wall 51. The starting material of the foam was poured into the mould as a granular material via a suitable pouring means. The granular material used can be foamed by a chemical reaction. For this purpose, it contains a foaming agent. In the present example, the foaming agent is designed to evaporate through heat input. Through the heat input the starting material is likewise melted, which subsequently foams due to the evaporating foaming agent.

FIG. 19 represents a further example of an alternative bicycle component part. By way of example, it is also explained for this alternative with reference to a front fork how the alternative bicycle component part is constructed and how it is produced. The example is based on the representation of the front fork of FIG. 10. According to FIG. 19, the bicycle component part is again formed as a one-piece hollow body, here the hollow fork body 50 with a component part wall, namely a fork wall 51. The fork wall 51 surrounds the cavity. It is produced from a thermoplastic in a closed mould. The one-piece nature of the fork wall 51 is again produced by means of a rotational moulding in a mould which is externally heatable for the rotational moulding.

The alternative of FIG. 19 differs from the example of FIG. 10 and from the example of FIG. 18 in that a foam 126, which in the present example coats the component part wall of this bicycle component part, namely a fork wall 51, on its inside facing the cavity, is additionally arranged in the hollow fork body 50. Although the cavity of the hollow fork body 50 thereby decreases, it does not disappear.

### LIST OF REFERENCE NUMBERS

1 main frame
2 hollow body
3 frame wall
3a frame wall
3b frame wall
3c data storage element
4 main support
5 rear wheel support
5a rear region
6 top tube element
7 down tube element
8 seat tube element
9 head tube element
10 lower node
11 pedal drive receiver
12 pedal drive housing
13 triangular structure
14 upper support element
15 lower support element
15a front end
16 housing (drive means)
17 upper node
18 rear node
19 rear wheel receiver
20 bearing opening
21 bearing opening
22 bridge element
23 open region
24 seat tube extension
25 intermediate element
26 grip element
27 maintenance opening
28 maintenance cover
29 bearing opening
30 bearing opening
31 upper opening (head tube element)
32 upper opening (seat tube element)
33 inner locating surface (bearing opening 20)
34 inner locating surface (bearing opening 21)
40 front fork
41 fork bridge region
42 left fork leg
42a thicker region (fork wall)
43 right fork leg
43a thicker region (fork wall)
44 left fork arm
45 right fork arm
46 handlebar element
47 fork shaft
48 left handlebar half
49 right handlebar half
50 hollow fork body
51 fork wall
51a data storage element
52 dropout
53 dropout
54 fastening element
55 closure element
55a connection means
56 receiving opening
56a adapter element
56b central opening
57 closure element
57a connection means
58 receiving opening
58a adapter element
58b central opening
59 front axle
60 axle element
60a connection end
61 axle element
61a connection end
62 external thread
63 internal thread
64 bearing seat
65 mating region
65a bar
65b bar
66 bearing seat
67 mating region
67a bar
67b bar
68 connection system
69 double-chamber element
70 double-chamber side
70a top conical piece
70b bottom conical piece
71a top conical piece
71b bottom conical piece
72 lower clamping element
73 inner surface (lower clamping element)
74 upper clamping element
75 inner surface (upper clamping element)
76 through opening
77 adjustment screw
78 nut element
79 claw nut
80 claws
81 bicycle frame
100 rear wheel
101 rear axle
101a thread end
101b thread end
102 disc element
102a through opening
103 hub sleeve
103a seat
104 roller bearing
105 hollow cylindrical internal space
106 roller bearing
107 freewheel element
108 axle nut
109 axle nut
110 roller bearing
111 roller bearing
112 sprocket
120 plain bearing element
121 bearing opening
122 bearing opening
125 foam filling
126 foam layer
D drive side
W wheel side
M middle line

1. A main frame (1) for a bicycle with a saddle, as well as with a front wheel and a rear wheel, which are arranged in one track, produced from a thermoplastic in a closed mould, wherein it is designed as a one-piece hollow body (2) with a frame wall (3) surrounding its cavity, and in that the frame wall (3) of the hollow body (2) has a one-piece nature, which is produced by means of a rotational moulding in an externally heatable rotational mould.

2. The main frame (1) according to claim 1, wherein the hollow body (2) has regions with different wall thickness of the frame wall (3).

3. The main frame (1) according to claim 2, wherein the regions of different wall thickness of the frame wall (3) are generated by a heat input into the rotational mould from the outside which is different in regions.

4. The main frame (1) according to claim 1, wherein the thermoplastic of the frame wall (3) is selected from one of the following plastics: polypropylene (PP), polyethylene (PE), and high-density polyethylene (HDPE).

5. The main frame (1) according to claim 1, wherein the thermoplastic is fibre-free.

6. A main frame (1) for a bicycle with a saddle, as well as with a front wheel and a rear wheel, which are arranged in one track, produced from a thermoplastic, wherein a main support (4) and a one-sided rear wheel support (5) are comprised in one piece, wherein the rear wheel support (5) is designed as a hollow body (2), the rear wheel support (5) forms an encapsulating housing (16) for a drive means, and that the rear wheel support (5) includes a rear wheel receiver (19), wherein the main support (4) is designed hollow overall with opposite frame walls (3a, 3b) and is designed in one piece with the rear wheel support (5).

7. The main frame (1) according to claim 6, wherein the rear wheel receiver (19) is formed as two coaxial bearing openings (20, 21), in that the coaxial bearing openings (20, 21) are arranged in the opposite frame walls (3a, 3b) of the rear wheel support (5).

8. The main frame (1) according to claim 7, wherein the frame wall (3) of the hollow body (2) has a one-piece nature, which is produced by means of a rotational moulding in an externally heatable rotational mould.

9. The main frame (1) according to claim 8, wherein the hollow body (2) has regions with different wall thickness of the frame wall (3).

10. The main frame (1) according to claim 7, wherein the regions of different wall thickness of the frame wall (3) are generated by a heat input into the rotational mould from the outside which is different in regions.

11. (canceled)

12. (canceled)

13. (canceled)

14. (canceled)

15. (canceled)

16. (canceled)

17. (canceled)

18. (canceled)

19. The main frame (1) according to claim 1, wherein the internal volume of the hollow body (2) is at least partially provided with a foam.

20. (canceled)

21. (canceled)

22. (canceled)

23. (canceled)

24. (canceled)

25. (canceled)

26. A front fork (40) for a bicycle, which has a saddle, and which is provided with a front wheel and a rear wheel, which are arranged single-tracked, produced from a thermoplastic in a closed mould, wherein the front fork includes at least one fork leg (42, 43) formed as a hollow fork body (50) with a fork wall (51), and in that the fork wall (51) of the hollow fork body (50) has a one-piece nature, which is produced with a rotational moulding in an externally heatable rotational mould.

27. The front fork (40) according to claim 26, wherein the hollow fork body (50) has regions with different wall thickness of the fork wall (51).

28. The front fork (40) according to claim 27, wherein the regions of different wall thickness of the fork wall (51) are generated by a heat input into the rotational mould from the outside which is different in regions.

29. A front fork (40) for a bicycle, which has a saddle, and which is provided with a front wheel and a rear wheel, which are arranged single-tracked, formed in one piece from a thermoplastic, comprising either a fork leg (42, 43) located on one side and having an upper end and a lower end or two such fork legs (42, 43) arranged symmetrically, wherein a receiving opening (56, 58) is provided in each case at the lower end of the fork leg or the lower ends of the two fork legs (42, 43), and wherein the receiving opening (56, 58) is adapted to hold a front axle (59), wherein a fork bridge region (41), to which, on one side, a fork arm (44, 45) which is oriented upwards is attached or two symmetrically arranged fork arms (44, 45) which are oriented upwards are attached, is formed at the upper end of the fork leg (42, 43).

30. The front fork (40) according to claim 29, wherein the fork arm (44, 45) has an upper end, and in that the upper end of the fork arm (44, 45) is connected to a handlebar element (46).

31. The front fork (40) according to claim 30, wherein the handlebar element (46) is formed in one piece as part of the hollow fork body (50).

32. The front fork (40) according to claim 29, wherein the receiving opening (56, 58) of the fork leg (42, 43) is configured for holding a front axle (59) forms a downwardly open dropout (52, 53), into which the front axle (59) can be inserted from the side.

33. The front fork (40) according to claim 32, further comprising a closure element (55, 57) with which the downwardly open dropout (52, 53) can be closed.

34. (canceled)

35. (canceled)

36. (canceled)

37. The front fork (40) according to claim 29, wherein the one-piece nature of the hollow fork body (50) is produced by means of a rotational moulding in an externally heatable rotational mould.

38. The front fork (40) according to claim 37, wherein the hollow fork body (50) has regions with different wall thickness of the fork wall (51).

39. The front fork (40) according to claim 38, wherein the regions of different wall thickness of the fork wall (51) are generated by a heat input into the rotational mould from the outside which is different in regions.

40. The front fork (40) according to claim 29, wherein a front axle (59) is allocated as a structural component part.

41. The front fork (40) according to claim 40, wherein the front axle (59) comprises two cup-shaped or two hollow cylindrical axle elements (60, 61), in that each axle element (60, 61) has a bearing seat (64) for a wheel bearing as well as a mating region (65) for the purposes of connection to the dropout (52, 53) of a fork leg (42, 43), in that the mating region (65) has a cylindrical or polygonal cross section, and with the proviso that the unit consisting of dropout (52, 53) and closure element (55, 57) has a matching hollow cylindrical or hollow polygonal cross section.

42. The front fork (40) according to claim 41, wherein the two axle elements (60, 61) can be connected to each other in a line in order to produce an axle connection, in that each axle element (60, 61) has a connection end (60a, 61a), and in that the axle connection can be produced by means of the connection ends (60a, 61a).

43. (canceled)

44. (canceled)

45. (canceled)

46. (canceled)

47. A bicycle frame (81) for a bicycle with a saddle, as well as with a front wheel and a rear wheel in one track, comprising a main frame (1) according to claim 1, as well as comprising a front fork (40) having at least one fork leg (42, 43) formed as a hollow fork body (50) with a fork wall (51), and in that the fork wall (51) of the hollow fork body (50) has a one-piece nature, which is produced by means of a rotational moulding in an externally heatable rotational mould.

48. The bicycle frame according to claim 47, wherein the front fork (40) has two fork legs (42, 43).

49. (canceled)

50. A bicycle component part from the group: main frame, front fork and wheel, comprising a one-piece hollow body (50) with a component part wall (51) surrounding its cavity, wherein the component part wall (51) of the hollow body (50) is produced from a thermoplastic in a closed mould, wherein the component part wall (51) has a one-piece nature, which is produced by means of a rotational moulding in an externally heatable mould designed for the rotational moulding, with the additional proviso that a foam is arranged in the cavity, and that the foam extends at least partially as a foam layer (126) over the inside of the component part wall (51) or completely fills the cavity as a foam filling (125).

51. A method for manufacturing a main frame (1) for a bicycle where a front wheel and a rear wheel are arranged in one track, the method comprising:
pouring a thermoplastic material into a rotational mould having a negative shape of the main frame;
closing the rotational mould;
rotating about at least one axis while externally heating the rotational mould;
solidifying the main frame; and
opening the rotational mould to remove the main frame from the rotational mould, and
wherein the main frame is designed as a one-piece hollow body (2) with a frame wall (3) surrounding its cavity, and in that the frame wall (3) of the hollow body (2) has a one-piece structure.
